(19) United States
(12) Patent Application Publication
(10) Pub. No.: US 2008/0145007 A1
(43) Pub. Date: Jun. 19, 2008

(54) Electronic device and method for manufacturing the same

(76) Inventor: Eric Crumpton, Severna Park, MD (US)

Correspondence Address: BERENATO, WHITE & STAVISH, LLC, 6550 ROCK SPRING DRIVE, SUITE 240, BETHESDA, MD, 20817, US

(21) Appl. No.: 11/637,780

(22) Filed: Dec. 13, 2006

(51) Int. Cl. G02B 6/44

(52) U.S. Cl. 385/94; 264/1.24

(57) ABSTRACT

An electronic device comprises a hollow housing defining an enclosed cavity therewithin, an electronic unit disposed within the cavity, and a potting compound filling the cavity in the housing and encapsulating at least one electronic component of the electronic unit. The potting material has a compressive strength allowing the electronic device to withstand pressure of up to 10,000 psi. A method for manufacturing the electronic device comprises the steps of: providing the housing with the enclosed cavity therewithin, inserting the electronic unit into the cavity, providing the potting material, and introducing the potting material into the cavity so that a space around the electronic unit is filled with the potting material to encapsulate the electronic unit.

### BACKGROUND OF THE INVENTION

1. Field of the Invention

This invention pertains to electronic devices in general and, more particularly, to an electronic device provided to withstand high pressure conditions and a method for manufacturing the same.

2. Description of the Prior Art

Fiber-optic transceivers are the heart of a multiplexer system that transmits video and data across a fiber optical cable. Fiber-optic cable transmission lines have become more widely used in various electronic applications including fiber-optic transceivers because of their inherent capability of transmitting more data than any comparably sized electrical wire. Since fiber-optic cables do not produce electromagnetic interference and are not susceptible to radio frequency interference, they have become more desirable in computer systems and avionic systems and many other types of systems in which noise interference can cause malfunction thereof. Moreover, fiber optic cable transmission systems have an additional advantage of having lower power requirements than electrical wire transmission lines of comparable data transmission capabilities.

The fiber-optic transceivers are available and in use for operating in various high pressure applications (at pressures up to 10,000 psi), such as under sea, in deep oil wells or the like. For example, in the under sea applications, the fiber-optic transceivers, mounted to undersea robots or robotic vehicles, are subject to water pressure from about 5,000 psi to approximately 10,000 psi. The fiber-optic transceivers are subject to comparably high pressure also in decompressing chambers for deep sea divers or the like.

Typically, the fiber-optic transceivers for high pressure applications include specialized high-pressure housings enclosing electronic components of the fiber-optic transceivers and specialized connectors used for power input and signal I/O (input/output). In order to withstand elevated pressure conditions, these housings are usually custom fabricated of thick gauge titanium, aluminum, composite material or stainless steel to withstand high sub-sea pressures of up to 10,000 psi. However, such a construction makes the metal housings of the fiber-optic transceivers heavy, bulky and expensive.

Thus, while known fiber-optic transceivers, including but not limited to those discussed above, have proven to be acceptable for various high pressure applications, such devices are nevertheless susceptible to improvements that may reduce their weight, size and cost. With this in mind, a need exists to develop improved fiber-optic transceivers that advance the art.

### SUMMARY OF THE INVENTION

The present invention is directed to a novel electronic device provided for operating in various high pressure applications, and a method for manufacturing the same.

According to one aspect of the invention, an electronic device is provided for operating in various high pressure applications (at pressures up to 10,000 psi). The electronic device comprises a hollow housing defining an enclosed cavity therewithin, an electronic unit disposed within the cavity, and a potting compound filling the cavity in the housing and encapsulating at least one electronic component of the electronic unit. The electronic unit includes at least one electronic component. The potting material has a compressive strength allowing the electronic device to withstand pressure of up to 10,000 psi.

According to another aspect of the invention, a method for manufacturing the electronic device is provided. The method of the present invention comprises the following steps. First, a hollow housing with the enclosed cavity therewithin is provided. Next, the electronic unit is inserted into the cavity in the housing. Then, the potting material is introduced into the cavity so that a space around the electronic unit is filled with the potting material to encapsulate the electronic unit. The potting material has the compressive strength allowing the electronic device to withstand pressure of up to 10,000 psi.

### BRIEF DESCRIPTION OF THE DRAWINGS

Objects and advantages of the invention will become apparent from a study of the following specification when viewed in light of the accompanying drawings, wherein:

FIG. 1 is a front perspective view of a fiber-optic transceiver in accordance with a preferred embodiment of the present invention;

FIG. 2 is a rear perspective view of the fiber-optic transceiver in accordance with the preferred embodiment of the present invention;

FIG. 3 is a top view of the fiber-optic transceiver according to the preferred embodiment of the present invention;

FIG. 4 is a side view of the fiber-optic transceiver of the present invention;

FIG. 5 is a bottom view of the fiber-optic transceiver of the present invention;

FIG. 6 is a rear view of the fiber-optic transceiver according to the preferred embodiment of the present invention;

FIG. 7 is a top view of an electronic unit according to the preferred embodiment of the present invention;

FIG. 8 is a side view of the electronic unit according to the preferred embodiment of the present invention;

FIG. 9 is a cross-sectional view of the fiber-optic transceiver according to the preferred embodiment of the present invention;

FIG. 10 shows the step of degassing a potting material.

### DESCRIPTION OF THE PREFERRED EMBODIMENTS

The preferred embodiments of the present invention will now be described with the reference to accompanying drawing.

For purposes of the following description, certain terminology is used in the following description for convenience only and is not limiting. The words such as “top” and “bottom”, “upper” and “lower”, “left” and “right” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

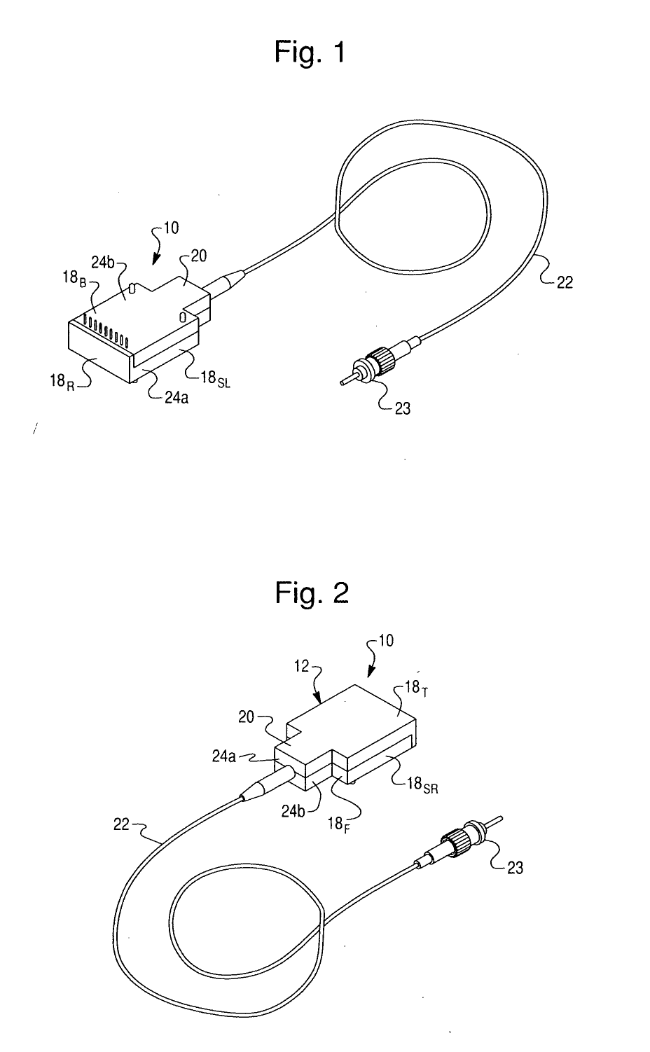

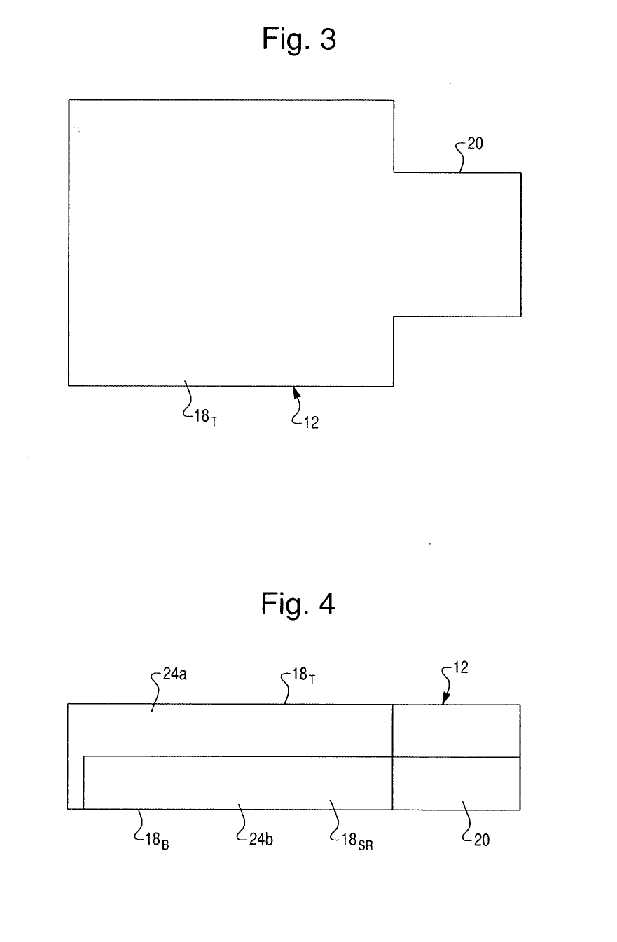

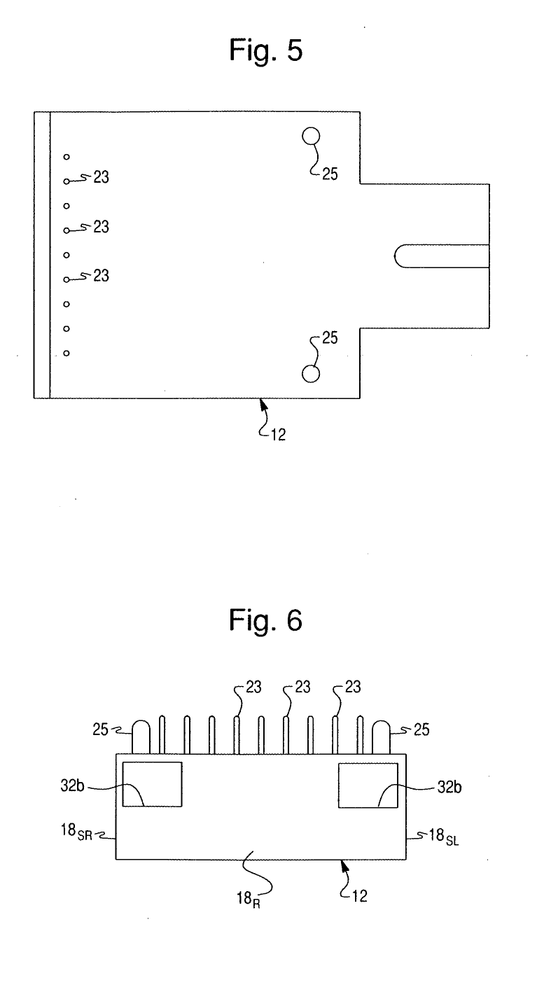

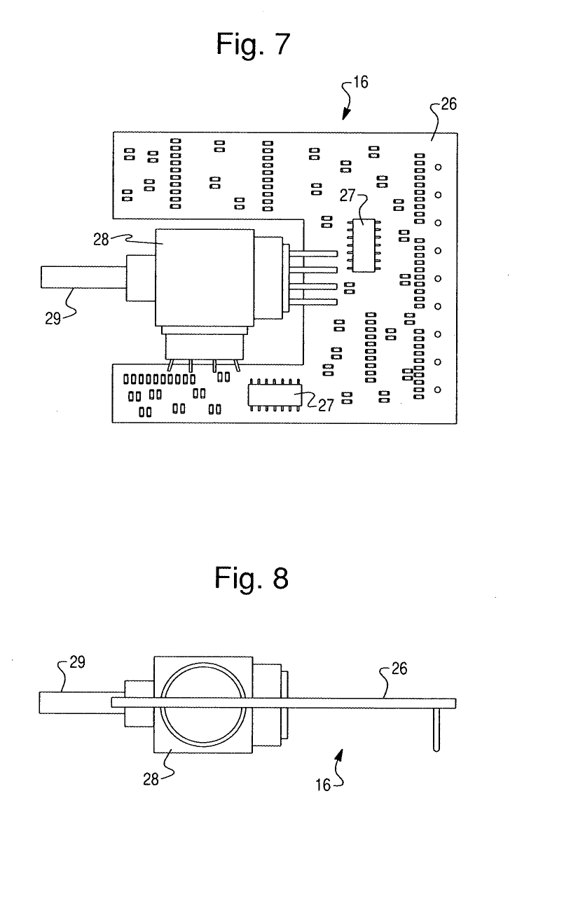

The present invention relates to a fiber-optic transceiver for a multiplexer system that transmits video and data across a fiber optical link. FIGS. 1-9 of the drawings depict a preferred embodiment of the fiber-optic transceiver of the present invention generally denoted by reference numeral 10. While the preferred embodiment of the present invention is described with reference to the fiber-optic transceiver, it will be appreciated that the present invention is equally applicable to any electronic device packaged into an enclosed housing, especially for various high pressure applications.

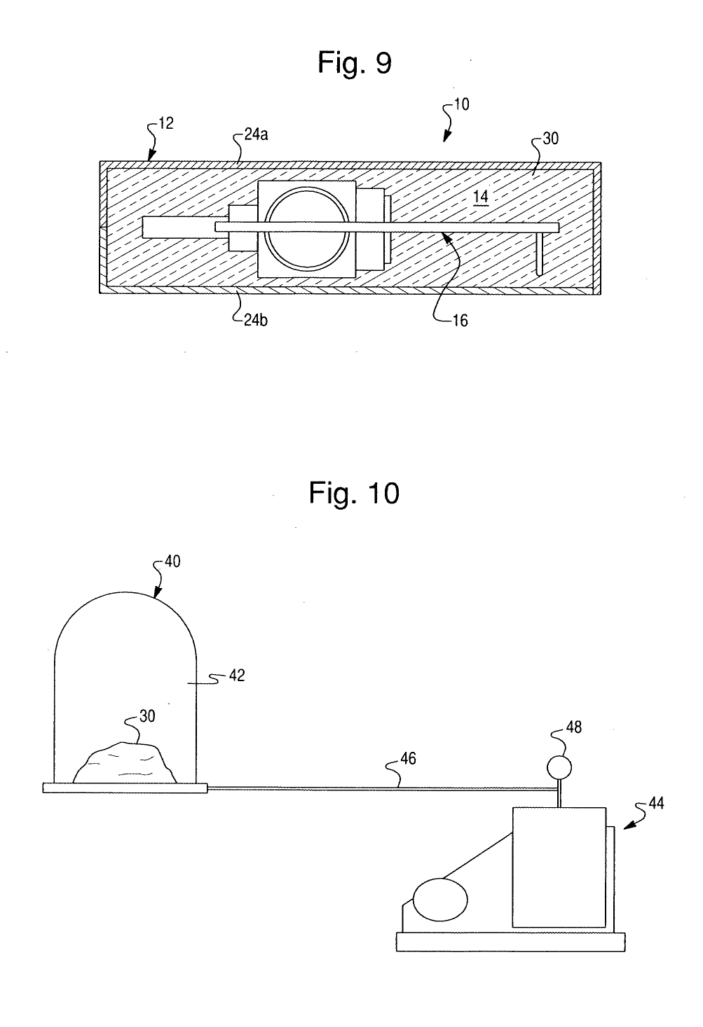

The fiber-optic transceiver 10 comprises a housing 12 that defines an enclosed cavity 14 therein (shown in FIG. 9), and an electronic unit 16 disposed within the cavity 14. The housing 12 has opposite top and bottom walls 18_{T} and 18_{B}, respectively, opposite right and left side walls 18_{SR} and 18_{SL}, respectively, and opposite front and rear walls 18_{F} and 18_{R}, respectively. The housing 12 further includes a nose portion 20 receiving a proximal end of a fiber optic cable 22. A distal end of the fiber optic cable 22 is provided with a cable connector 23. The nose portion 20 is formed integrally with the housing 12 and extends outwardly from the front wall 18_{F} thereof. Preferably, the housing 12 is made of complementary top and bottom portions 24a and 24b, respectively, connected to each other so as to form the enclosed cavity 14. Further preferably, the housing 12 is made of any appropriate plastic material. It will be appreciated that alternatively the housing 12 may be made of non-corrosive metal, such as stainless steel.

The cavity 14 is formed so as to accommodate and protect the electronic unit 16. The electronic unit 16 comprises a printed circuit board 26 including at least one electronic component secured thereto, such as semiconductor integrated circuit devices 27, and a fiber-optic splitter 28 operatively coupled to the printed circuit board 26 and having a terminal 29. The printed circuit board 26 is provided with a transmitter and receiver handling circuitry including a transmitter for converting electrical data signals to corresponding optical data signals and a receiver for converting optical data signals back to electrical data signals. The terminal 29 of the fiber-optic splitter 28 is coupled to the proximal end of the fiber optic cable 22. The electronic unit 16 further includes electrical contacts 23 and grounding pins 25.

A space in the enclosed cavity 14 of the housing 12 around the electronic unit 16 is filled with a potting material 30, as illustrated in FIG. 9. According to the present invention, the potting material 30 has compressive strength from about 5,000 psi to about 10,000 psi. The compressive strength is a measure of material's ability to withstand a compression force without failure. The potting material 30 may be of any composition known to a worker skilled in the art. This may include potting material that is cured with the application of heat or the potting material that is mixed just prior to the filling of the cavity 14 and that hardens due to the mixture of several components. In the exemplary embodiment of the present invention, the thermally conductive epoxy encapsulating and potting compound 832-TC produced by the MG Chemicals is used as the potting material 30 filling the cavity 14 of the housing 12. The conventional potting material has a compressive strength of well below 5,000 psi when fully cured and hardened. For example, the above mentioned potting compound 832-TC produced by the MG Chemicals when fully cured and hardened has the compressive strength of only 4,088 psi. Such value of the compressive strength of the conventional potting material is not sufficient for high pressure applications subject to pressure up to 10,000 psi, e.g. under sea, in deep oil wells or the like. Therefore, prior to being introduced into the cavity 14, the original potting material is degassed (i.e. freed from air bubbles therein) in order to substantially increase the compressive strength thereof.

A method for manufacturing the fiber-optic transceiver 10 according to the preferred embodiment of the present invention comprises the following steps.

First, the complementary top and bottom portions 24a and 24b of the housing 12 are provided. The housing 12 is formed with one or more access openings provided for introducing the potting material 30. In the exemplary embodiment shown in FIGS. 1-6, the rear wall 18_{R} (the upper portion 24a) of the housing 12 is formed with two access openings 32a and 32b into the cavity 14. The access openings 32a and 32b may be formed by any appropriate method known in the art, such as by cutting holes through one of the walls of the housing 12.

Next, the printed circuit board 26 of the electronic unit 16 is placed into the bottom portion 24b of the housing 12 and rested on appropriate mounting pin(s) or ledge(s) or other devices (not shown) that are commonly known to a person skilled in the art to support and properly position the electronic unit 16 within the housing cavity 14. Moreover, the printed circuit board 26 s placed into the bottom portion 24b of the housing 12 so as to provide a space between the electronic unit 16 and the bottom portion 24b. Then, the top portion 24a is attached to the bottom portion 24b in order to assemble the housing 12 defining the enclosed cavity 14 so as to provide a space between the electronic unit 16 and the top portion 24a. Thus, the electronic unit 16 is disposed within the cavity 14 so as to provide the space in the enclosed cavity 14 around the electronic unit 16.

After that, the housing 12 is covered with molding clay material (not shown) with the exception of the access openings 32a and 32b so as to block gaps in joints between the top and bottom portions 24a and 24b of the housing 12. Alternatively, the housing 12 may be placed into an appropriate mold (not shown) covering up the housing 12, but leaving the access openings 32a and 32b open.

In the following method step, the conventional potting material, such as the potting compound 832-TC produced by the MG Chemicals mentioned above, is provided. Then, the original potting material is mixed and degassed (i.e. freed from air bubbles therein) in order to substantially increase the compressive strength thereof.

Specifically, prior to being introduced into the cavity 14, the original potting material 30 is mixed and put into a vacuum chamber 42 within a vacuum bell jar 40 for degassing, as illustrated in FIG. 10. The vacuum chamber 42 of the vacuum bell jar 40 is fluidly connected to a vacuum pump 44 through a vacuum line 46. Once the vacuum within the vacuum chamber 42 reaches 29-30 inches of mercury (as monitored by a vacuum gauge 48), the original potting material will begin to rise, resembling foam. Further increase of the vacuum causes the potting material to fall and not rise any more because substantially all air is removed from the potting material 30. At this point, the potting material 30 is substantially degassed. Preferably, the process of vacuuming continues for about 20 more minutes to make certain that all of the air has been removed from the original potting material.

Subsequently, the potting material 30 is introduced into the cavity 14 of the housing 12 using any appropriate technique known in the art. For example, the degassed potting material 30 may be put into a syringe (not shown) and introduced into the cavity 14 using the syringe, or the housing 12 may be put into a mold and the degassed potting material 30 introduced into the cavity 14 using any appropriate injection machine.

The degassed potting material 30 is introduced (injected) into the cavity 14 of the housing 12 of the fiber-optic transceiver 10 through the first access hole 32a acting as an inlet port, naturally flows within and fills the cavity 14 encapsulating the electronic unit 16, and escapes the cavity 14 through the second access hole 32b acting as an exit port and, possibly, through gaps between the top and bottom portions 24a and 24b of the housing 12. In fact, the degassed potting material 30 may be introduced into the cavity 14 of the housing 12 through either or both of the access holes 32a and 32b. Alternatively, only one access hole in the housing 12 could be provided.

It will be appreciated that above process of injecting the degassed potting material into the housing 12 does not usually introduce any new bubbles into the degassed (vacuumed) potting material. However, in order to insure that the potting material 30 is completely devoid of air bubbles, the entire fiber-optic transceiver 10 is placed back into the vacuum chamber 42 of the vacuum bell jar 40 for a few additional minutes right after filling the housing 12 with the potting material but before the potting material hardens (or cures) for an additional (repeated) degassing. This process step of additional (second or repeated) degassing also assists the degassed potting material to fill difficult to reach areas of the cavity 14 of the housing 12 in order to completely fill the cavity 14.

Then, the potting material 30 is either cured by the application of heat or generates heat on its own due to the chemical reactions required by mixing several components to create a hardened mixture. In the exemplary embodiment of the present invention, the fiber-optic transceiver 10 is heated in an oven (not shown) to 60° C. to cure and harden the potting material 30 within the housing 12.

Subsequently, once the potting material 30 has fully cured, the housing 12 is trimmed to remove burrs of the excess potting material extending from the gaps in the housing 12, and the access openings 32a and 32b are sealed with the potting material 30 in flush with the rear wall 18_{R} of the housing 12.

Finally, the fiber-optic transceiver 10 is electrically tested and pressure cycled, or tested, under fluid pressure of about 10,000 psi.

Therefore, the present invention provides a novel electronic device, such as a fiber-optic transceiver 10, and a method for manufacturing the same, which is securely protected in the high fluid-pressure environment by encapsulating electronic components thereof with a potting material having a compressive strength allowing the electronic device to withstand pressure of up to 10,000 psi.

The foregoing description of the preferred embodiment of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A method for manufacturing a fiber-optic transceiver, said method comprising the steps of:
a) providing a housing defining an enclosed cavity therewithin;
b) inserting an electronic unit into said cavity;
c) providing a potting material; and
d) introducing said potting material into said cavity so that an entire space in said cavity around said electronic unit being completely filled with said potting material to encapsulate said electronic unit; and
curing said potting material in said housing in order to harden said potting material subsequent to the step of introducing said potting material into said cavity;
said potting material being a thermally conductive epoxy potting compound having a compressive strength from about 5,000 psi to about 10,000 psi after the step of curing said potting material.

2. The method for manufacturing said fiber-optic transceiver as defined in claim 1, wherein said step of providing said potting material includes the step of degassing said potting material so as to make said potting material substantially free of air bubbles.

3. The method for manufacturing said fiber-optic transceiver as defined in claim 2, wherein the step of degassing said potting material includes the step of vacuuming said potting material in a vacuum chamber by a vacuum pump.

4. The method for manufacturing said fiber-optic transceiver as defined in claim 3, wherein said compressive strength of said potting material after the step of degassing said potting material is from about 5,000 psi to about 10,000 psi.

5. The method for manufacturing said fiber-optic transceiver as defined in claim 1, wherein the step of providing said housing includes the step of forming at least one access opening in said housing.

6. The method for manufacturing said fiber-optic transceiver as defined in claim 5, wherein step of introducing said potting material into said cavity is conducted through said at least one access opening.

7. The method for manufacturing said fiber-optic transceiver as defined in claim 6, further including the step of covering said housing with molding material with the exception of said at least one access opening so as to block gaps in said housing executed prior to the step of introducing said potting material into said cavity.

8. The method for manufacturing said fiber-optic transceiver as defined in claim 2, further including the step of additional degassing of said potting material within said housing subsequent to the step of introducing said potting material into said cavity.

9. The method for manufacturing said fiber-optic transceiver as defined in claim 8, wherein the step of additional degassing of said potting material includes the step of vacuuming said potting material in a vacuum chamber by a vacuum pump.

10. (canceled)

11. The method for manufacturing said fiber-optic transceiver as defined in claim 1, wherein said step of curing said potting material includes the step of heating said electronic device in order to cure and harden said potting material in said housing.

12. The method for manufacturing said fiber-optic transceiver as defined in claim 1, further including the step of testing said electronic device under fluid pressure of about 10,000 psi subsequent to the step of curing said electronic device.

13. (canceled)

14. A fiber-optic transceiver An electronic device comprising:
a hollow housing defining an enclosed cavity therewithin;
an electronic unit disposed within said cavity, said electronic unit having at least one electronic component; and
a potting compound completely filling an entire space in said cavity in said housing around said electronic unit so as to encapsulate said electronic unit;
said potting material being a thermally conductive epoxy potting compound having a compressive strength from about 5,000 ps to about 10,000 psi when fully cured.

15. (canceled)

16. The fiber-optic transceiver as defined in claim 14, wherein said potting material is substantially free of air bubbles.

17. The fiber-optic transceiver as defined in claim 16, wherein said potting material is degassed prior to filling said cavity in said housing.

18. The fiber-optic transceiver as defined in claim 17, wherein said degassing of said potting material was conducted in a vacuum chamber by a vacuum pump.

19. (canceled)
